(19) United States
(12) Patent Application Publication
(10) Pub. No.: US 2024/0245128 A1
(43) Pub. Date: Jul. 25, 2024

(54) AEROSOL GENERATING DEVICE WITH SUPPORT PROVIDING AIR TO AEROSOL GENERATING ARTICLE

(71) Applicant: KT&G CORPORATION, Daejeon (KR)

(72) Inventors: Dong Sung KIM, Seoul (KR); Young Bum KWON, Gyeonggi-do (KR); Yong Hwan KIM, Gyeonggi-do (KR); Hun Il LIM, Seoul (KR); Seok Su JANG, Daejeon (KR)

(73) Assignee: KT&G CORPORATION, Daejeon (KR)

(21) Appl. No.: 18/562,974

(22) PCT Filed: Nov. 10, 2022
(86) PCT No.: PCT/KR2022/017638

§ 371 Date: Nov. 21, 2023

(30) Foreign Application Priority Data
Nov. 11, 2021 (KR) 10-2021-0155186
Apr. 21, 2022 (KR) 10-2022-0049541

(51) Int. Cl. A24F 40/48; A24F 40/465; H05B 6/10

(52) U.S. Cl. CPC A24F 40/48; A24F 40/465; H05B 6/105

(57) ABSTRACT

Provided is an aerosol-generating device including a housing in which an aerosol-generating article is accommodated, a heater which is arranged at an external side of the aerosol-generating article to heat the aerosol-generating article accommodated in the housing, and at least one support which is arranged at an inner space of the housing, supports the aerosol-generating article accommodated in the housing, and allows air in the inner space of the housing to flow to one end of the aerosol-generating article.

### TECHNICAL FIELD

Embodiments relate to an aerosol-generating device, and more particularly, to an aerosol-generating device including a support for providing air to an aerosol-generating article.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on a heated aerosol generating device is being actively conducted.

### DISCLOSURE OF INVENTION

### Technical Problem

In order to generate an aerosol in an aerosol-generating device, it is required to smoothly provide air to an aerosol-generating article (e.g., cigarette).

When air flows into the aerosol-generating article through one end thereof, the flow and amount of air may vary depending on the surrounding structure of the aerosol-generating article. The amount and quality of smoking may be determined according to the flow and amount of the inflowing air.

Various embodiments of the present disclosure are explained to improve the vaporization amount and the quality of smoking by largely increasing the amount of air flowing into the aerosol-generating article.

The technical problems of various embodiments of the present disclosure are not limited to the above-described description, and other technical problems may be clearly understood by one of ordinary skill in the art from the embodiments to be described hereinafter.

### Solution to Problem

An aerosol-generating device according to an embodiment may include a housing including an inner space for accommodating an aerosol-generating article; a heater which is arranged outside of the aerosol-generating article to heat the aerosol-generating article accommodated in the inner space; and at least one support which is arranged in the inner space, supports the aerosol-generating article, and guides air introduced into the inner space to one end of the aerosol-generating article.

### Advantageous Effects of Invention

An aerosol-generating device according to various embodiments of the present disclosure may improve the vaporization amount and the quality of smoking through the abundant inflow of air to an aerosol-generating article.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol-generating device according to an embodiment.

FIG. 2 is a cross-sectional view of an aerosol-generating device according to the embodiment shown in FIG. 1.

FIG. 3 is an exploded perspective view of an aerosol-generating device according to an embodiment.

FIG. 4 is a cross-sectional view of the aerosol-generating device illustrated in FIG. 3.

FIG. 5 is an enlarged view of a part of the aerosol-generating device illustrated in FIG. 3.

FIG. 6 illustrates an air flow in an enlarged view of a portion of the aerosol-generating device illustrated in FIG. 3.

FIG. 7 illustrates the air flow and a height by which the aerosol-generating device is spaced apart from the bottom surface, in an enlarged view of a portion of the aerosol-generating device illustrated in FIG. 3.

FIG. 8 is a perspective view of a part obtained by cutting a part of the aerosol-generating device illustrated in FIG. 3.

FIG. 9 illustrates a structure of a support of the aerosol-generating device illustrated in FIG. 3.

FIG. 10 is a block diagram of an aerosol-generating device according to another embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

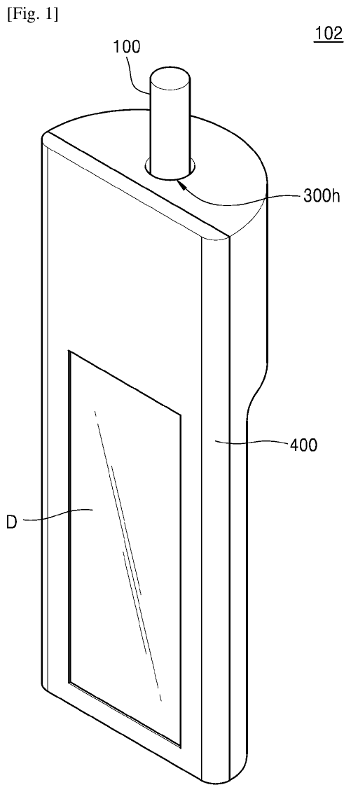

FIG. 1 is a perspective view of an aerosol-generating device 102 according to an embodiment.

Referring to FIG. 1, the aerosol-generating device 120 according to an embodiment may include a housing 400 into which an aerosol-generating article 100 may be inserted.

The housing 400 may form the overall appearance of the aerosol-generating device 102, and components of the aerosol-generating device 102 may be arranged in the inner space of the housing 400. For example, a heater and a battery may be arranged in the inner space of the housing, but components, which are arranged in the inner space, are not limited thereto.

FIG. 1 illustrates that the cross-section of the aerosol-generating device 102 (i.e., the housing 400) is a semicircular column shape, but the shape of the aerosol-generating device 102 is not limited thereto. For example, the aerosol-generating device 102 may be formed as a cylindrical shape or a polygonal column (e.g., a triangular column or a quadrangular column).

The housing 400 may include an accommodation space 300h for accommodating at least a portion of the aerosol-generating article 100. The aerosol-generating article 100 may be inserted into (or accommodated in) the housing through the accommodation space 300h, and the aerosol-generating article 100, which is inserted into the housing 400, may be heated by a heater inside the housing 400.

As the aerosol-generating article 100 is heated, aerosol may be generated from the aerosol-generating article 100. The user may inhale aerosol discharged from the aerosol-generating article 100.

The aerosol-generating device 102 may further include a display D on which visual information is displayed. The display D may be arranged such that at least a partial region of the display D is exposed to the external side of the housing 400. The aerosol-generating device 102 may provide various visual information to the user through the display D.

For example, the aerosol-generating device 102 may provide information on whether there has been the user's puffing action or information on the number of remaining puffs of the inserted aerosol-generating article 100 through the display D, but the information provided through the display D may be modified in various ways.

In addition, the aerosol-generating device 102 may control the operation of the aerosol-generating device 102, based on a user's input on the display D. For example, the aerosol-generating device 102 may control whether to operate the heater or the temperature profile of the heater, based on the user's input (e.g., a touch input) on the display D, but the control operation of the aerosol-generating device 102 is not limited thereto.

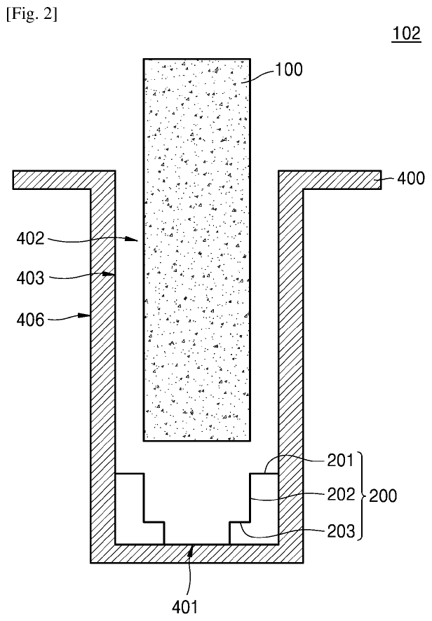

FIG. 2 is a cross-sectional view of an aerosol-generating device 102 according to the embodiment shown in FIG. 1.

Referring to FIG. 2, the aerosol-generating device 102 may include a housing 400 for accommodating an aerosol-generating article 100, and a support 200 which is disposed inside the housing 400 and supports the aerosol-generating device 102.

Various components of the aerosol-generating device 102 may be disposed inside the inner space 402 of the housing 400. For example, a heater, an insertion unit, and a support 200 may be arranged in the inner space 402 of the housing 400, but the components, which are arranged in the inner space 402 of the housing 400, are not limited thereto.

The housing 400 may include an insertion unit for accommodating at least a portion of the aerosol-generating article 100. A heater for heating the aerosol-generating article 100 accommodated in the inner space 402 of the housing 400 may be arranged outside of the aerosol-generating article 100.

The support 200 may be disposed in the inner space 402 of the housing 400.

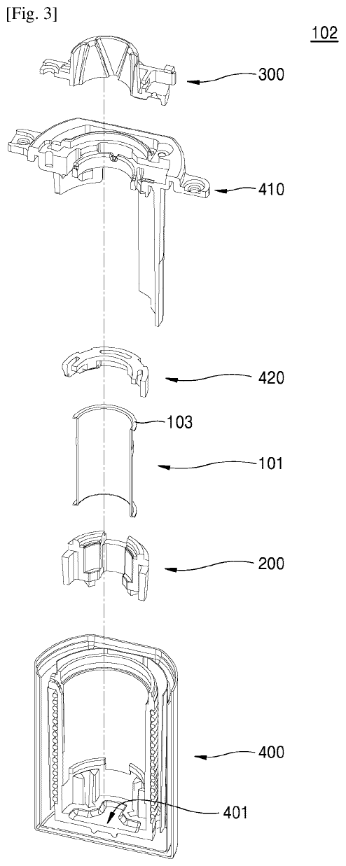

The support 200 may support at least one of the aerosol-generating article 100 and the heater 101 (see FIG. 3). The support 200 may include at least one of an end support 203, a side support 202, and a heater support 201.

The end support 203 may support at least a portion of one surface of the one end of the aerosol-generating article 100. The side support 202 may support at least a part of the side surface of the aerosol-generating article 100. The heater support 201 may support at least a part of the heater 101.

The support 200 may have a shape which protrudes toward the inner space 402 from a bottom surface 401 of the housing 400. For example, the protruding shape of the support 200 may be formed by the heater support 201 and the end support 203 extending in the longitudinal direction of the inner space of the housing 400.

One or more layers may be formed by the heater support 210 and the end support 203. In FIG. 2, the heater support 201 and the end support 203 may form two layers. The wall of the support 200, which connects the heater support 201 and the end support 203, may be the side support 202.

According to an embodiment, the housing 400 may include an inner space 402 for accommodating at least a portion of the aerosol-generating article 100. The aerosol-generating article 100 may be inserted into (or accommodated in) the housing 400 through the inner space 402. The aerosol-generating article 100, which is inserted into the housing 400, may be heated by a heater 101 inside the housing 400.

The aerosol, which is generated at the inside of the housing 400 as the aerosol-generating article 100 is heated, may be discharged to the outside of the aerosol-generating device 102 through the aerosol-generating article 100, and the user may inhale the discharged aerosol.

FIG. 3 is an exploded perspective view of an aerosol-generating device 102 according to an embodiment.

Referring to FIG. 3, the aerosol-generating device 102 may include a housing 400, an insertion unit 300, a support 200, and a heater 101. At least one of components of the aerosol-generating device 102 may be the same as or similar to at least one of components of the aerosol-generating device 102 illustrated in FIG. 2, and descriptions that are the same as those given above will be omitted.

Embodiments are not limited by the shape of the insertion unit 300 illustrated in FIG. 3. The insertion unit 300 may have various shapes which may be accommodated in or inserted into the inner space 402 of the housing 400.

The insertion unit 300 may have a shape suitable for supporting at least a partial region of the aerosol-generating article 100 which is accommodated in or inserted into the inner space 402 of the housing 400. Further, the insertion unit 300 may include an empty space for receiving the aerosol-generating article 100 into the inner space 402 of the housing 400.

The insertion unit 300 may allow external air to flow into the inner space 402 of the housing 400, thereby allowing air to flow into the aerosol-generating article 100. The insertion unit 300 may include a hole for allowing the external air to flow into the inner space 402 of the housing 400.

Referring to FIG. 3, the aerosol-generating device 102 may further include an upper frame 410 and an inflow frame 420.

The upper frame 410 may be coupled to the insertion unit 300 and the housing 400. The inflow frame 420 may be coupled to the upper frame 410.

The inflow frame 420 may include one or more holes for allowing the external air to flow into the inner space 402 of the housing 400. The holes of the inflow frame 420 may be arranged to correspond to the holes of the insertion unit 300.

Referring to FIG. 3, the heater 101 may have a form which surrounds the aerosol-generating article 100, but the heater 101 is not limited thereto. The heater 101 may have various forms which may heat the aerosol-generating article 100 from the outside.

The heater 101 may include a flange 103 which is bent outwards at one end and/or both ends. As the heater support 201 of the support 200 supports the flange 103 of the heater 101, the heater 101 may be allowed to be spaced apart from the bottom surface 401 of the housing 400.

The support 200 may be formed as a portion of the bottom surface 401 or the inner wall 403 of the housing 400. Alternatively, as illustrated in FIG. 3, the support 200 may be separated from the housing 400.

For example, the support 200 and the bottom surface 401 of the housing 400 may have a protrusion and a groove, respectively, which may be coupled to each other. Shapes of the support 200 and the bottom surface 401 of the housing 400 are not limited to the protrusion and the groove and may be modified in various shapes which may be coupled to each other.

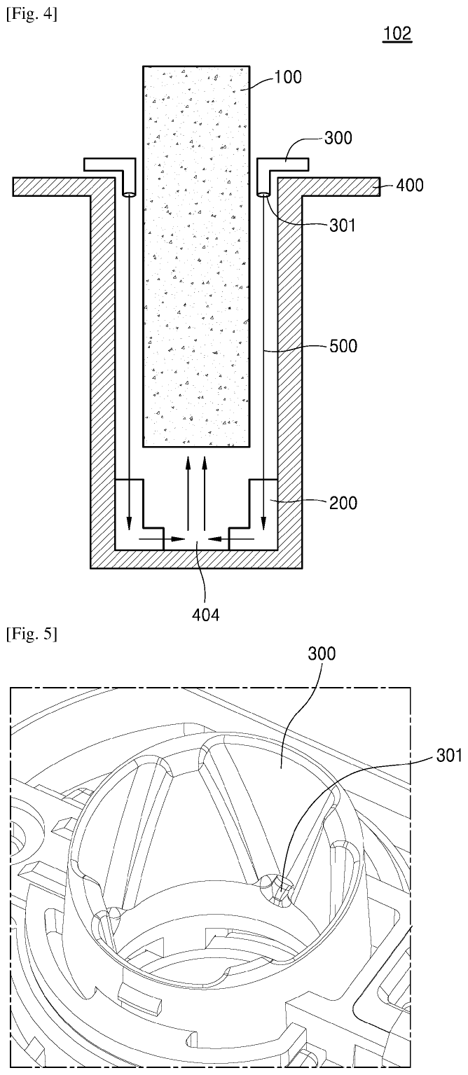

FIG. 4 is a cross-sectional view of the aerosol-generating device 102 illustrated in FIG. 3.

An air flow 500 may vary according to the arrangement of the insertion unit 300 and the support 200 of the housing 400.

For example, referring to FIG. 4, the air flow 500 may be formed by external air flowing into the inner space 402 of the housing 400 through an inflow hole 301 of the insertion unit 300. The air flow 500 may be formed in the longitudinal direction of the aerosol-generating article 100 (i.e., in a direction from one end of the aerosol-generating article 100 to the other end of the aerosol-generating article 100). The air may flow into the aerosol-generating article 100 through the end (i.e., upstream end) of the aerosol-generating article 100.

The housing 400 may further include an insertion unit 300, and the insertion unit 300 may further include an inflow hole 301.

The inflow hole 301 may allow the external air to flow into the inner space 402 of the housing 400. The inflow hole 301 may be a round hole. However, the shape of the inflow hole 301 is not limited thereto, and the inflow hole 301 may have various shapes which may allow the external air to flow into the inner space 402 of the housing 400.

One or more inflow holes 301 may be included in the insertion unit 300. A plurality of inflow holes 301 may be arranged in the insertion unit 300 in the circumferential direction of the insertion unit 300. The external air may flow into the inner space 402 of the housing 400 through the inflow hole 301 of the insertion unit 300.

The amount of the air flow 500 may become abundant as the inner space 404 of the bottom surface of the housing 400 is formed. The abundant air flow 500 may improve the amount and the quality of smoking of the aerosol-generating device 102.

For example, referring to FIG. 4, the inner space 404 of the bottom surface may be formed by the space between one end of the aerosol-generating article 100 and the bottom surface 401 of the housing 400. One end of the aerosol-generating article 100 may be spaced apart from the bottom surface 401 of the housing 400 by the end support 203 of the support 200.

As the aerosol-generating article 100 is sufficiently spaced apart from the bottom surface 401 of the housing 400, the abundant air flow 500 may be directed to the aerosol-generating article 100. The abundant air flow 500 may improve the amount and the quality of smoking of the aerosol-generating device 102.

The air flow 500 may vary according to the shape of the support 200.

The support 200 may have a shape which protrudes toward the inner space 402 on the bottom surface 401 of the housing 400, or a shape which protrudes toward the inner space 420 on the inner wall 403 of the housing 400.

As the support 200 does not protrude on a middle of the inner wall 403 of the housing 400, the air flow 500 between the inflow hole 301 and the bottom surface 401 of the housing 400 may have a certain directionality.

As the air flow 500 has a certain directionality, the twist of the air flow 500 in the inner space 402 of the aerosol-generating device 102 may be reduced. As the twist of the air flow is reduced, the abundant air may enter one end of the aerosol-generating article 200 according to the air flow 500.

The abundant air flow 500 may improve the amount and the quality of smoking of the aerosol-generating device 102.

FIG. 5 is an enlarged view of a part of the aerosol-generating device 102 illustrated in FIG. 3.

FIG. 5 illustrates an insertion unit 300 and an inflow hole 301 of an aerosol-generating device 102 according to an embodiment.

The aerosol-generating device 102 may include an insertion unit 300. The insertion unit 300 may include one or more inflow holes 301.

The inflow hole 301 is an air inlet through which external air flows into the inner space 402 of the aerosol-generating device 102. The inflow holes 301 may be arranged in the circumferential direction of the insertion unit 300.

According to one embodiment, referring to FIG. 5, the insertion unit 300 may include one or more trapezoidal shapes.

As shown in FIG. 5, the insertion unit 300 may include 4 embossed trapezoidal shapes and 4 engraved trapezoidal shapes, which are alternately arranged in the circumferential direction of the insertion unit 300.

When observed from above (i.e., from a viewpoint looking at the bottom surface 401 through the insertion unit 300), in the length of the lower side may be smaller than the length of the upper side in the embossed trapezoidal shape, and the length of the lower side may be greater than the length of the upper side in the engraved trapezoidal shape.

The engraved trapezoidal shape may have an inflow hole 301 on the lower side.

The position and size of the inflow hole 301 may determine the position and amount of the air which enters the inner space 402 of the housing 400 according to the air flow 500. The air flow 500 may be directed to the inner space 402 of the housing 400 through four inflow holes 301.

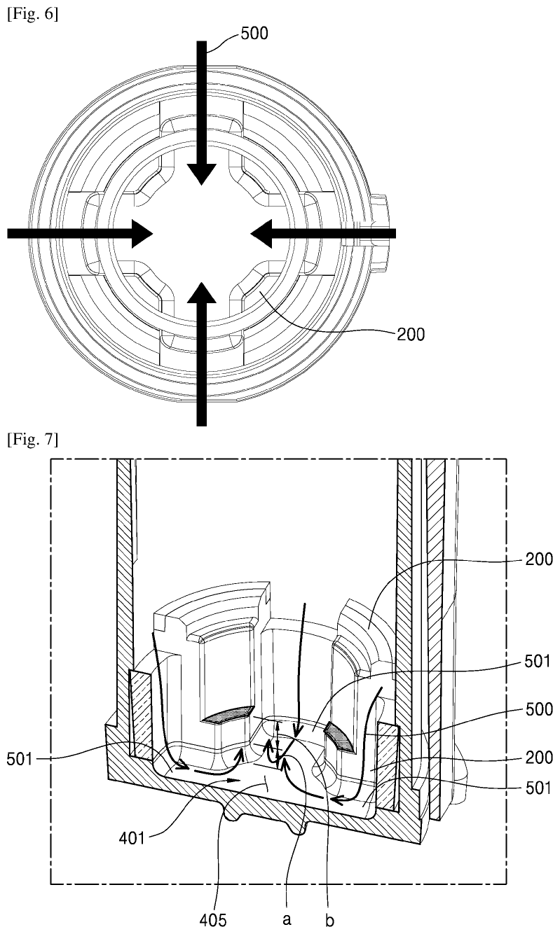

Referring to FIG. 6, the air flow 500 may have the form of a cross when observed from above.

FIG. 6 illustrates an air flow on an enlarged view of a portion of the aerosol-generating device illustrated in FIG. 3.

Referring to FIG. 6, there may be a plurality of supports 200, depending on the embodiment.

The plurality of supports 200 may be arranged in the circumferential direction of the housing 400 on the bottom surface 401 of the housing 400. An empty space may be formed between the plurality of supports 200.

The air may pass through an empty space formed between a plurality of supports 200 in the inner space of the housing 300 and flow into the aerosol-generating article 100 according to the air flow 500. The empty space, which is formed between the plurality of supports 200, may determine the direction and amount of the air flow 500.

Referring to FIG. 6, four supports 200 may be arranged in the circumferential direction of the housing 400 on the bottom surface 401 of the housing 400. An empty space may be formed between adjacent supports at regular intervals as four supports 200 are arranged.

The air may pass through an empty space between four supports 200 formed at regular intervals and flow into the aerosol-generating article 100 according to the air flow 500. The air flow 500 may have a form of a cross when observed from above, as shown in FIG. 6.

The air flow 500 at the insertion unit 300 and the air flow 500 at the support 200 may have a form of a cross at corresponding positions, but the present disclosure is not limited thereto.

FIG. 7 illustrates the air flow and a height by which the aerosol-generating device is spaced apart from the bottom surface, on an enlarged view of a portion of the aerosol-generating device illustrated in FIG. 3.

The air supply passage 501 is a passage through which air may enter the aerosol-generating article 100 from the bottom surface 401 of the housing 400.

The external air may move to the bottom surface 401 along the side of the aerosol-generating article 100 in the inner space 402 of the housing 400 and flow into the aerosol-generating article 100 through the air supply passage 501.

For example, the aerosol-generating device 102 may include the insertion unit 300 of FIG. 5 and the support 200 of FIG. 6.

Four embossed trapezoidal shapes and four engraved trapezoidal shapes may be alternately arranged in a circumferential direction of the insertion unit 300. The insertion unit 300 may include four inflow holes 301.

Four supports 200 may be arranged at regular intervals in the circumferential direction of the housing 400 on the bottom surface 401 of the housing 400. As four empty spaces are formed between adjacent supports, four air supply passages 501 may be formed.

When observed from above, the insertion unit 300 and the support 200 may be arranged such that the location of the inflow hole 301 correspond to the location of the air supply passage 501. In other words, the inflow hole 301 may be aligned with the air supply passage 501 in the longitudinal direction of the inner space 402. As the location of the inflow hole 301 corresponds to the location of the air supply passage 501, the twist of the air flow 500 may be reduced in the inner space 402 of the housing 400.

When observed from above, the air flow 500 in the insertion unit 300 and the air flow 500 in the support 200 may have the same form. According to an embodiment, the air flow 500 may all have a form of a cross, but the present disclosure is not limited thereto.

As the air flow 500 in the insertion unit 300 and the air flow 500 in the support 200 have the same form, the twist of the air flow 500 in the inner space 402 of the housing 400 may be reduced.

The aerosol-generating device 102 may include a support 200 which protrudes toward the inner space 402 of the housing 400 on the bottom surface 401 of the housing 400 and the inner wall 403 of the housing 400.

The aerosol-generating device 102 may include a support 200 which protrudes toward the inner space 402 of the housing 400 on the bottom surface 401 of the housing 400 and the inner wall 403 of the housing 400. The aerosol-generating device 102 may further include a support 200 which protrudes toward the inner space 402 of the housing 400 on the inner wall 403 of the housing 400.

The support 200 protrudes toward the inner space 402 of the housing 400 in the inner wall 403 of the housing 400 only when protruding together with the bottom surface 401 of the housing 400.

As the support 200 does not protrude on a middle of the inner wall 403 of the housing 400, the air flow 500 between the inflow hole 301 and the bottom surface 401 of the housing 400 may have a certain directionality.

As the air flow 500 has a certain directionality, the twist of the air flow 500 in the inner space 402 of the aerosol-generating device 102 may be reduced.

The amount of the air flow 500 which enters into the aerosol-generating article 100 may determine the performance related to the vaporization amount or the smoking quality of the aerosol-generating device 102. When the amount of the air entering the aerosol-generating article 100 according to the air flow 500 is abundant, the vaporization amount and the smoking quality of the aerosol-generating device 102 may be improved.

When the twist of the air flow 500 is reduced, the amount of the air entering the aerosol-generating article 100 according to the air flow 500 may become abundant.

As the location of the inflow hole 301 of the insertion unit 300 corresponds to the location of the air supply passage 501, the air flow 500 in the insertion unit 300 has the same form as that of the air flow 500 near the support 200, or the air flow 500 formed along the side of the aerosol-generating article 100 has a constant directionality, the twist of the air flow 500 in the inner space of the housing 400 may become reduced.

The aerosol-generating device 102 may include a chamber 405 as an inner component of the housing 400.

The chamber 405 may accommodate the air flow 500 in which air flows through the air supply passage 501 of the support on the bottom surface 401 and flows into one end of the aerosol-generating article 100.

The form of the chamber 405 may vary depending on the form and arrangement of the plurality of supports 200. The volume of the chamber 405 may be increased as a part of the bottom surface 401 of the housing 400 where the supports 200 are not arranged is sunken.

The shape and volume of the chamber 405 may affect the amount of air flow 500 entering the aerosol-generating article 100 inserted or accommodated in the housing 400. As the chamber 405 accommodates the air flow 500 on the bottom surface 401 of the housing 400, the amount of air flowing into the aerosol-generating article 100 according to the air flow 500 becomes abundant.

The separation distance between the aerosol-generating article 100 and the bottom surface 401 of the housing 400 may determine the amount of the air flow 500 which may be accommodated by the chamber 405. The amount of the air flow 500, which may be accommodated by the chamber 405, may determine the performance related to the vaporization amount and the quality of smoking of the aerosol-generating device 102.

The sunken part (hereinafter “lower portion”) of the bottom surface 401 of the housing 400 may form a side surface which is exposed to the inner space 402 of the housing 400.

Referring to FIG. 7, height “a” is the height of the side surface of the lower portion of the bottom surface 401 of the housing 400, which is exposed to the inner space 402 of the housing 400. The height a is a vertical distance from the lower portion of the bottom surface 401 of the housing 400 to the rest of the bottom surface 401 (hereinafter “higher portion of the bottom surface 401”) where the bottom surface 401 of the housing 400 contacts the support 200.

Referring to FIG. 7, the height b is a vertical distance from the higher portion of the bottom surface 401 to the end support 203 of the support 200.

The aerosol-generating article 100 may be spaced apart from the bottom surface 401 of the housing 400 by the end support 203 of the support 200. If the bottom surface 401 of the housing 400 includes the lower portion as shown in FIG. 7, the aerosol-generating article 100 may be spaced apart from the bottom surface 401 of the housing 400 by the sum of the height a and the height b.

The sum of the height a and the height b may determine the amount of the air flow 500 entering the aerosol-generating article 100.

When the sum of the height a and the height b is greater than or equal to 0.1 mm and is less than or equal to 4 mm, the amount of the air flow 500 entering the aerosol-generating article 100 may improve the performance related to the amount and the quality of smoking of the aerosol-generating device 102.

Preferably, when the sum of the height a and the height b is about 2 mm, the amount of the air flow 500 entering the aerosol-generating article 100 may improve the performance related to the amount and the quality of smoking of the aerosol-generating device 102.

In another example, the aerosol-generating device 102 may include a housing 400 in which the bottom surface 401 of the housing 400 and the support 200 are integrally formed. In this case, the height b may be 0 mm.

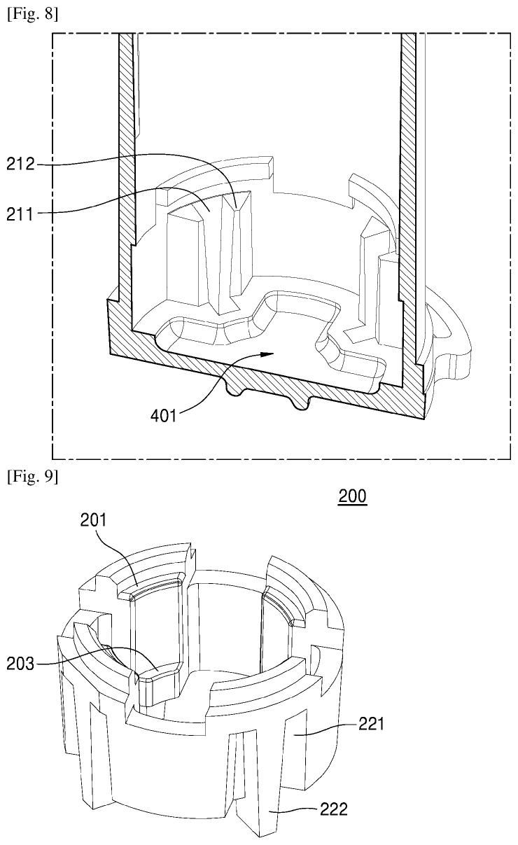

FIG. 8 is a perspective view of what is obtained by cutting a part of the aerosol-generating device illustrated in FIG. 3, and FIG. 9 illustrates the structure of a support of the aerosol-generating device illustrated in FIG. 3.

The aerosol-generating device 102 may include a support 200 which protrudes toward the inner space 402 of the housing 400 on the bottom surface 401 of the housing 400 and the inner wall 403 of the housing 400.

The aerosol-generating device 102 may include a housing 400 and the support 200 which is detachable from the bottom surface 401 of the housing 400.

Alternatively, the support 200 and the bottom surface 401 of the housing 400 may be integrally formed.

In a case where the support 200 is detachable from the bottom surface 401 of the housing 400, the bottom surface 401 or the inner wall 403 of the housing 400 may have a protrusion 212 and a groove 211 which may be coupled to the support 200. Also, the support 200 may have a protrusion 222 and a groove 221 which may be coupled to the bottom surface 401 or the inner wall 403 of the housing 400.

Referring to FIGS. 8 and 9, one groove 211 and two protrusions 212 formed on the bottom surface 401 or the inner wall 403 of the housing 400 may be coupled to two grooves 221 and one protrusion 222 of the support 200.

The plurality of supports 200 may be arranged in the circumferential direction of the housing 400 on the bottom surface 401 of the housing 400.

If one coupling part is formed as one groove 211 and two protrusions 212 of the housing 400 are coupled to two grooves 221 and one protrusion 222 of the support 200, a plurality of supports 200 may form a plurality of coupling parts in the circumferential direction of the housing 400 on the bottom surface 401.

The support 200, the bottom surface 401 of the housing 400, and the inner wall 403 of the housing 400 may have other coupling structures as well as bumps and grooves.

In the case of the support 200 detachable from the bottom surface 401 of the housing 400, the support 200 and the housing 400 may be made of different materials.

The support 200 may include a heater support 201 and an end support 203. The heater support 201 may support the heater 102. The end support 203 may support the aerosol-generating article 100.

For example, at least a portion of the support 200 may be made of a material having high heat resistance to support the heater 101 and the aerosol-generating article 100.

The housing 400 may be made of a material that is easy to cast to have a shape that can be combined with the support 200.

In the case of the support 200 and the bottom surface 401 of the housing 400 which are integrally formed, the housing 400 may have the same material properties as the support 200.

For example, at least a portion of the housing 400 may be made of a material having high heat resistance to support the heater 101 and the aerosol-generating article 100.

Referring to FIG. 9, the aerosol-generating article 100 may include a support 200 which forms the heater support 201 and the end support 203 which have different heights.

The heater support 201 may protrude toward the inner space 402 of the housing from the inner wall 403 of the housing 400. As the support 200 includes a heater support 201, the heater 101 may be spaced apart from the inner wall 403 of the housing 400.

The heater 101 may include a flange 103 at one end (see FIG. 3). The flange 103 may be bent outwards. The heater support 201 may support the flange 103 of the heater 101.

As the heater 101 includes a flange 103, the heater 101 may be spaced apart from the inner wall 403 of the housing 400.

The heater support 201 may support the flange 103 of the heater 101. The heater 101 may be separated from the inner wall 403 of the housing 400 by the support 200.

As such, the housing 400 may be made of a material that does not have strong heat resistance.

The aerosol-generating device 102 may further include an induction coil. The induction coil may be arranged at the external surface 406 of the housing 400. The aerosol-generating device 102 may generate an induced magnetic field by allowing electric current to flow through the induction coil.

The heater 101 may be susceptor. The susceptor may generate heat by the induced magnetic field.

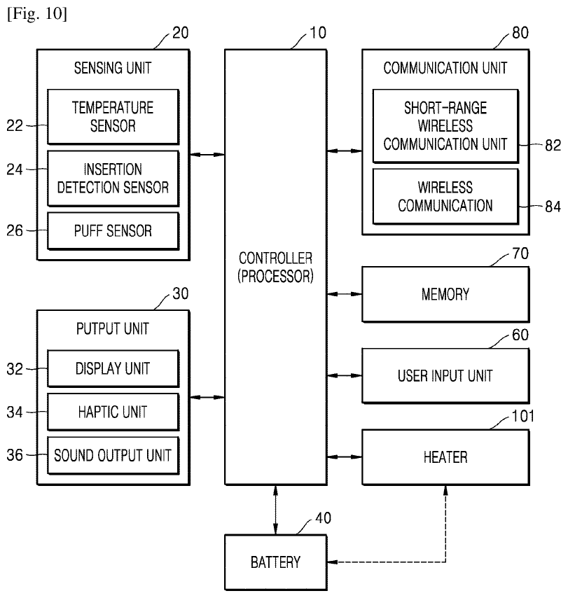

FIG. 10 is a block diagram of an aerosol generating device 102 according to another embodiment.

The aerosol generating device 102 may include a controller 10, a sensing unit 20, an output unit 30, a battery 40, a heater 101, a user input unit 60, a memory 70, and a communication unit 80. However, the internal structure of the aerosol generating device 102 is not limited to those illustrated in FIG. 10. That is, according to the design of the aerosol generating device 102, it will be understood by one of ordinary skill in the art that some of the components shown in FIG. 10 may be omitted or new components may be added.

The sensing unit 20 may sense a state of the aerosol generating device 102 and a state around the aerosol generating device 102, and transmit sensed information to the controller 10. Based on the sensed information, the controller 10 may control the aerosol generating device 102 to perform various functions, such as controlling an operation of the heater 101, limiting smoking, determining whether an aerosol generating article (e.g., a cigarette, a cartridge, or the like) is inserted, displaying a notification, or the like.

The sensing unit 20 may include at least one of a temperature sensor 22, an insertion detection sensor 24, and a puff sensor 26, but is not limited thereto.

The temperature sensor 22 may sense a temperature at which the heater 101 (or an aerosol generating material) is heated. The aerosol generating device 102 may include a separate temperature sensor for sensing the temperature of the heater 101, or the heater 101 may serve as a temperature sensor. Alternatively, the temperature sensor 22 may also be arranged around the battery 40 to monitor the temperature of the battery 40.

The insertion detection sensor 24 may sense insertion and/or removal of an aerosol generating article. For example, the insertion detection sensor 24 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 26 may sense a user's puff on the basis of various physical changes in an airflow passage or an airflow channel. For example, the puff sensor 26 may sense a user's puff on the basis of any one of a temperature change, a flow change, a voltage change, and a pressure change.

The sensing unit 20 may include, in addition to the temperature sensor 22, the insertion detection sensor 24, and the puff sensor 26 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 30 may output information on a state of the aerosol generating device 102 and provide the information to a user. The output unit 30 may include at least one of a display unit 32, a haptic unit 34, and a sound output unit 36, but is not limited thereto. When the display unit 32 and a touch pad form a layered structure to form a touch screen, the display unit 32 may also be used as an input device in addition to an output device.

The display unit 32 may visually provide information about the aerosol generating device 102 to the user. For example, information about the aerosol generating device 102 may mean various pieces of information, such as a charging/discharging state of the battery 40 of the aerosol generating device 102, a preheating state of the heater 101, an insertion/removal state of an aerosol generating article, or a state in which the use of the aerosol generating device 102 is restricted (e.g., sensing of an abnormal object), or the like, and the display unit 32 may output the information to the outside. The display unit 32 may be, for example, a liquid crystal display panel (LCD), an organic light-emitting diode (OLED) display panel, or the like. In addition, the display unit 32 may be in the form of a light-emitting diode (LED) light-emitting device.

The haptic unit 34 may tactilely provide information about the aerosol generating device 102 to the user by converting an electrical signal into a mechanical stimulus or an electrical stimulus. For example, the haptic unit 34 may include a motor, a piezo-electric element, or an electrical stimulation device.

The sound output unit 36 may audibly provide information about the aerosol generating device 102 to the user. For example, the sound output unit 36 may convert an electrical signal into a sound signal and output the same to the outside.

The battery 40 may supply power used to operate the aerosol generating device 102. The battery 40 may supply power such that the heater 101 may be heated. In addition, the battery 40 may supply power required for operations of other components (e.g., the sensing unit 20, the output unit 30, the user input unit 60, the memory 70, and the communication unit 80) in the aerosol generating device 102. The battery 40 may be a rechargeable battery or a disposable battery. For example, the battery 40 may be a lithium polymer (LiPoly) battery, but is not limited thereto.

The heater 101 may receive power from the battery 40 to heat an aerosol generating material. Although not illustrated in FIG. 10, the aerosol generating device 102 may further include a power conversion circuit (e.g., a direct current (DC)/DC converter) that converts power of the battery 40 and supplies the same to the heater 101. In addition, when the aerosol generating device 102 generates aerosols in an induction heating method, the aerosol generating device 102 may further include a DC/alternating current (AC) that converts DC power of the battery 40 into AC power.

The controller 10, the sensing unit 20, the output unit 30, the user input unit 60, the memory 70, and the communication unit 80 may each receive power from the battery 40 to perform a function. Although not illustrated in FIG. 10, the aerosol generating device 102 may further include a power conversion circuit that converts power of the battery 40 to supply the power to respective components, for example, a low dropout (LDO) circuit, or a voltage regulator circuit.

In an embodiment, the heater 101 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 101 may be implemented by a metal wire, a metal plate on which an electrically conductive track is arranged, a ceramic heating element, or the like, but is not limited thereto.

In another embodiment, the heater 101 may be a heater of an induction heating type. For example, the heater 101 may include a suspector that heats an aerosol generating material by generating heat through a magnetic field applied by a coil.

The user input unit 60 may receive information input from the user or may output information to the user. For example, the user input unit 60 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 102 may further include a connection interface, such as a universal serial bus (USB) interface, and may connect to other external devices through the connection interface, such as the USB interface, to transmit and receive information, or to charge the battery 40.

The memory 70 is a hardware component that stores various types of data processed in the aerosol generating device 102, and may store data processed and data to be processed by the controller 10. The memory 70 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 70 may store an operation time of the aerosol generating device 102, the maximum number of puffs, the current number of puffs, at least one temperature profile, data on a user's smoking pattern, etc.

The communication unit 80 may include at least one component for communication with another electronic device. For example, the communication unit 80 may include a short-range wireless communication unit 82 and a wireless communication unit 84.

The short-range wireless communication unit 82 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 84 may include a cellular network communication unit, an Internet communication unit, a computer network (e.g., local area network (LAN) or wide area network (WAN)) communication unit, or the like, but is not limited thereto. The wireless communication unit 84 may also identify and authenticate the aerosol generating device 102 within a communication network by using subscriber information (e.g., International Mobile Subscriber Identifier (IMSI)).

The controller 10 may control general operations of the aerosol generating device 102. In an embodiment, the controller 10 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 10 may control the temperature of the heater 101 by controlling supply of power of the battery 40 to the heater 101. For example, the controller 10 may control power supply by controlling switching of a switching element between the battery 40 and the heater 101. In another example, a direct heating circuit may also control power supply to the heater 101 according to a control command of the controller 10.

The controller 10 may analyze a result sensed by the sensing unit 20 and control subsequent processes to be performed. For example, the controller 10 may control power supplied to the heater 101 to start or end an operation of the heater 101 on the basis of a result sensed by the sensing unit 20. As another example, the controller 10 may control, based on a result sensed by the sensing unit 20, an amount of power supplied to the heater 101 and the time the power is supplied, such that the heater 101 may be heated to a certain temperature or maintained at an appropriate temperature.

The controller 10 may control the output unit 30 on the basis of a result sensed by the sensing unit 20. For example, when the number of puffs counted through the puff sensor 26 reaches a preset number, the controller 10 may notify the user that the aerosol generating device 102 will soon be terminated through at least one of the display unit 32, the haptic unit 34, and the sound output unit 36.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol-generating device comprising:
a housing including an inner space for accommodating an aerosol-generating article;
a heater which is arranged outside of the aerosol-generating article to heat the aerosol-generating article accommodated in the inner space; and
at least one support which is arranged in the inner space, supports the aerosol-generating article, and guides air introduced into the inner space to one end of the aerosol-generating article.

2. The aerosol-generating device of claim 1, wherein the support includes an end support which contacts at least a portion of the one end of the aerosol-generating article.

3. The aerosol-generating device of claim 2, wherein the support further includes a side support for supporting at least a portion of a side surface of the aerosol-generating article.

4. The aerosol-generating device of claim 2, wherein the support further includes a heater support for supporting one end of the heater.

5. The aerosol-generating device of claim 1, wherein the support includes an end support which contacts the one end of the aerosol-generating article, and a heater support for supporting one end of the heater, and wherein the end support and the heater support of the support have different heights.

6. The aerosol-generating device of claim 1, wherein the at least one support includes a plurality of supports which are arranged in a circumferential direction of the inner space, and air is supplied to the one end of the aerosol-generating article through an air supply passage between adjacent supports.

7. The aerosol-generating device of claim 6, further comprising an insertion unit configured to receive the aerosol-generating article into the inner space, and support the aerosol-generating article accommodated in the inner space.

8. The aerosol-generating device of claim 7, the insertion unit comprises an inflow hole which allows external air to flow into the inner space.

9. The aerosol-generating device of claim 6, wherein the air supply passage and the inflow hole are aligned in a longitudinal direction of the inner space.

10. The aerosol-generating device of claim 1, wherein the at least one support is detachably coupled to a bottom surface or an inner wall of the housing.

11. The aerosol-generating device of claim 10, wherein one of the bottom surface and the housing includes a protrusion, and the other of the bottom surface and the housing includes a groove connected to the protrusion.

12. The aerosol-generating device of claim 1, wherein the heater is separated from an inner wall of the housing.

13. The aerosol-generating device of claim 12, wherein the heater includes a flange bent outwards at one end, and
wherein the at least one support includes a heater support configured to support the flange such that the heater is spaced apart from the inner wall of the housing.

14. The aerosol-generating device of claim 1, wherein the housing includes a chamber in which the one end of the aerosol-generating article inserted into the housing is positioned, and
wherein the chamber provides for accommodating air to be supplied to the aerosol-generating article.

15. The aerosol-generating device of claim 1, further comprising an induction coil arranged outside of the housing and configured to generate an induced magnetic field,
wherein the heater includes a susceptor configured to generate heat in response to the induced magnetic field.
